(19) United States
(12) Patent Application Publication
(10) Pub. No.: US 2025/0370209 A1
(43) Pub. Date: Dec. 4, 2025

(54) Wall Mount Enclosure with Sliding Splice Tray Holder Assembly

(71) Applicant: Panduit Corp., Tinley Park, IL (US)

(72) Inventor: Bon B. Sledzinski, Westmont, IL (US)

(73) Assignee: Panduit Corp., Tinley Park, IL (US)

(21) Appl. No.: 19/201,234

(22) Filed: May 7, 2025

Related U.S. Application Data
(60) Provisional application No. 63/654,257, filed on May 31, 2024.

(51) Int. Cl. G02B 6/44

(52) U.S. Cl. CPC G02B 6/4454; G02B 6/4446

(57) ABSTRACT

A wall mount enclosure designed to manage and organize fiber distribution. The wall mount enclosure includes a top, a bottom, a back, a front, and two sides. Linear guides are secured to the sides and a sliding splice tray holder assembly is attached to the linear guides. The splice tray holder assembly includes a splice tray holder and a plurality of splice trays secured to the splice tray holder. The splice tray holder includes sides with tabs extending from the splice tray holder. The tabs are positioned within the linear guides enabling the splice tray holder assembly to slide out of the wall mount enclosure to provide access to the splice trays installed on the splice tray holder.

### CROSS REFERENCE TO RELATED APPLICATION(S)

This application claims benefit to U.S. Provisional Patent Application No. 63/654,257, filed May 31, 2024, the entirety of which is hereby incorporated by reference herein.

### FIELD OF THE INVENTION

The present invention relates to a wall mount enclosure, and more particularly to a wall mount enclosure with a sliding splice tray holder assembly.

### BACKGROUND OF THE INVENTION

Wall mount enclosures designed to manage and organize fiber distribution are known. FIG. 1 illustrates a wall mount enclosure 20 designed to improve cable installation and maintenance. One of the key benefits of the wall mount enclosure 20 is the mechanism for mounting the splice trays 50. The wall mount enclosure 20 includes a splice tray holder 30 and a plurality of splice trays 50. As shown in FIGS. 2-4, the splice tray holder 30 includes a top 32 with a plurality of holes 34 and a bottom 40 with a plurality of snap fittings 42 and slot openings 44. The splice tray 50 includes an upper pin 52 and a lower pin 54. The upper pin 52 of the splice tray 50 fits into a hole 34 of the splice tray holder 30 and the lower pin 54 of the splice tray 50 snaps into the snap fitting 42 of the splice tray holder 30. This arrangement allows for easy removal of one splice tray 50 without disturbing the other splice trays, and also allows for rolodex-style sorting through the splice trays (see FIG. 5) because the splice trays 50 pivot on the pins 52, 54. As shown in FIG. 1, another advantage of the previous wall mount enclosure 20 is that it provides ample open space 22 for cable management. While the features described above are important, they occupy space in the wall mount enclosure thereby reducing the maximum number of splice trays the wall mount enclosure can hold.

As a result, there is a need for an improved wall mount enclosure that maximizes the number of splice trays while enabling sorting and removal of a single splice tray without disturbing other splice trays.

### SUMMARY OF THE INVENTION

A wall mount enclosure with a sliding splice tray holder assembly used to manage and organize fiber distribution. The wall mount enclosure has a top, a bottom, a back, a front, and two sides. Linear guides are secured to the sides of the wall mount enclosure, and the splice tray holder assembly is attached to the linear guides. The splice tray holder assembly includes a splice tray holder and a plurality of splice trays secured to the splice tray holder. The splice tray holder includes a top with a plurality of holes, a bottom with a plurality of slots, and sides with tabs extending from the splice tray holder. The tabs are positioned within the linear guides enabling the splice tray holder assembly to slide out of the wall mount enclosure to provide access to the splice trays installed on the splice tray holder.

### BRIEF DESCRIPTION OF THE DRAWINGS

FIG. 1 illustrates a front view of a prior art wall mount enclosure.

FIG. 2 illustrates a perspective view of the splice tray holder of FIG. 1 with a splice tray positioned to be mounted.

FIG. 3 illustrates a perspective view of the upper corner of the splice tray positioned to be mounted on the splice tray holder of FIG. 2.

FIG. 4 illustrates a perspective view of the lower corner of the splice tray positioned to be mounted to the splice tray holder of FIG. 2.

FIG. 5 illustrates a perspective view of a plurality of splice trays mounted to the splice tray holder of FIG. 2.

FIG. 6 illustrates a perspective view of the wall mount enclosure with a sliding splice tray holder assembly of the present invention.

FIG. 7 illustrates a perspective view of the wall mount enclosure of FIG. 6 with the splice tray holder assembly pulled forward.

FIG. 8 illustrates a perspective view of the splice tray holder and linear guides of FIG. 6.

FIG. 9 illustrates a perspective view of the wall mount enclosure of FIG. 6 with cable entry at the top front of the enclosure.

FIG. 10 illustrates a perspective view of the wall mount enclosure of FIG. 6 with cable entry at the bottom back of the enclosure.

### DETAILED DESCRIPTION

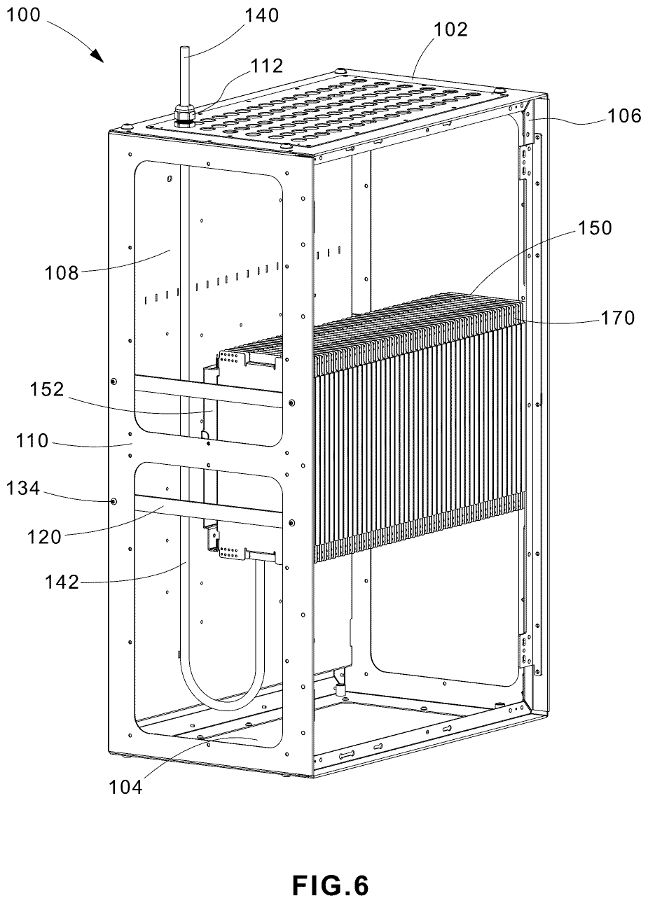

FIG. 6 illustrates a wall mount enclosure 100 with a top 102, a bottom 104, a front 106, a back 108, and sides 110. The wall mount enclosure 100 includes a cable entry 112 at the top 102 of the enclosure 100. A cable 140 having a slack loop 142 is routed in the enclosure behind the splice tray holder assembly 150. The wall mount enclosure 100 designed with the cable 140 routed behind the splice tray holder assembly 150 provides more space along the sides of the splice trays 170 for additional splice trays to be mounted to extend the width of the wall mount enclosure 100.

As illustrated in FIGS. 6-8, the wall mount enclosure 100 also includes extendable rails with linear guides 120 that are secured to the sides 110 of the wall mount enclosure 100 by fasteners 134. The linear guides 120 include a top 122 and a bottom 124 that define a channel 126. The linear guides 120 also include ends 128 with tabs 130 having a hole 132 for receiving the fastener 134 to mount the linear guides 120 to the sides 110 of the enclosure 100. The splice tray holder assembly 150 includes a splice tray holder 152 and a plurality of splice trays 170. The splice tray holder 152 includes a top 154 with holes 156, a bottom 158 with holes 160 designed to receive snap fittings and slots 162, and sides 164 with tabs 166 extending away from the splice tray holder 152. Similar to the splice trays 50 described above, splice trays 170 are attached to the splice tray holder 152 with an upper pin 172 of the splice tray 170 positioned in a hole 156 of the splice tray holder 152 and a lower pin 174 positioned in snap fittings and slots 162 of the splice tray holder 152.

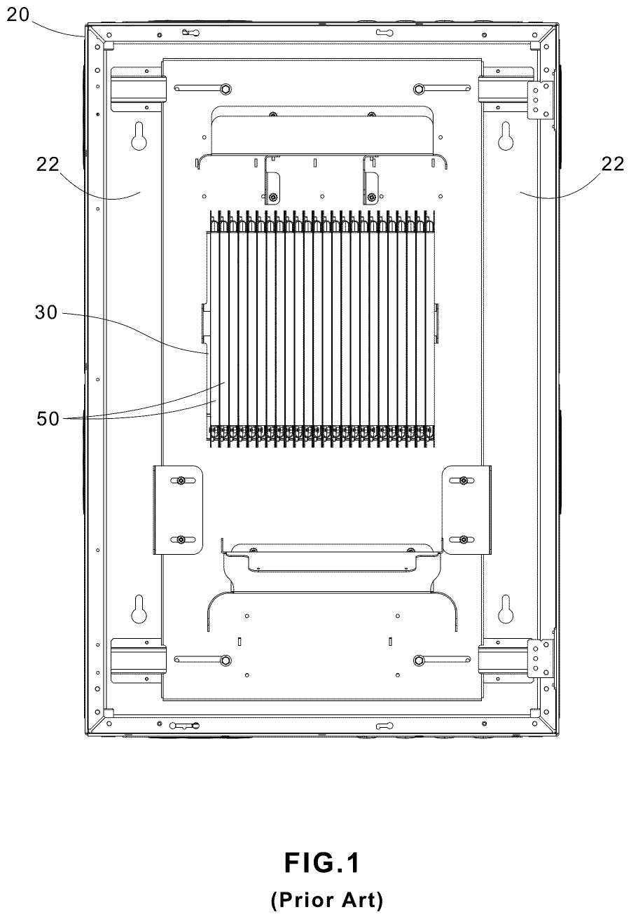

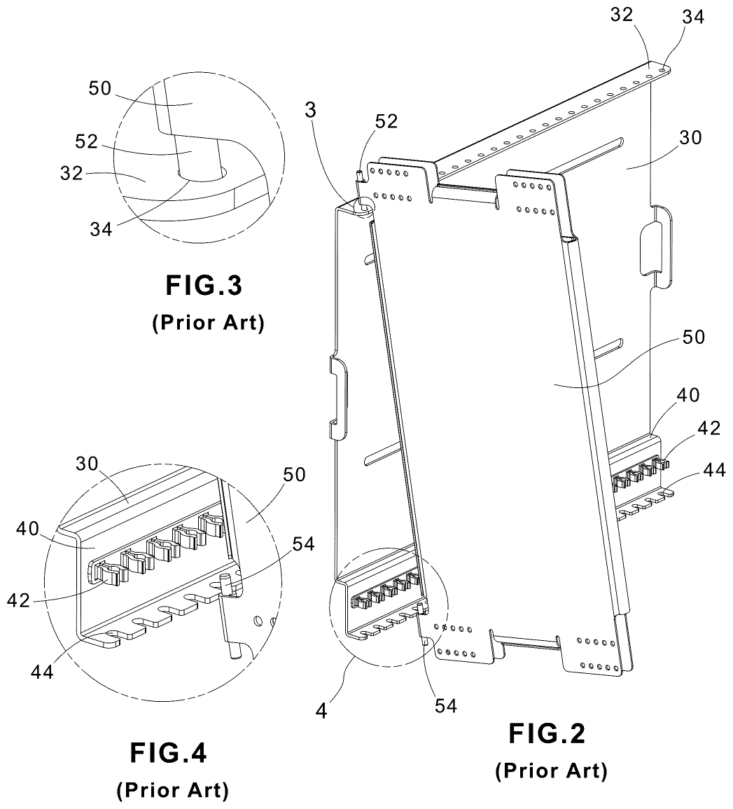

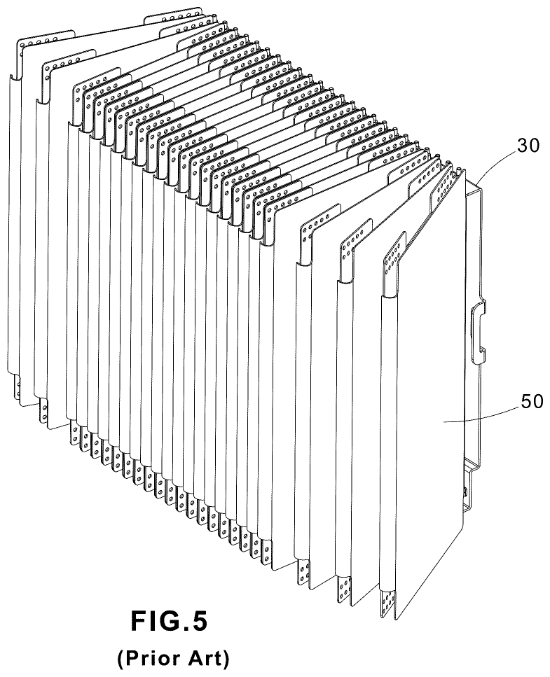

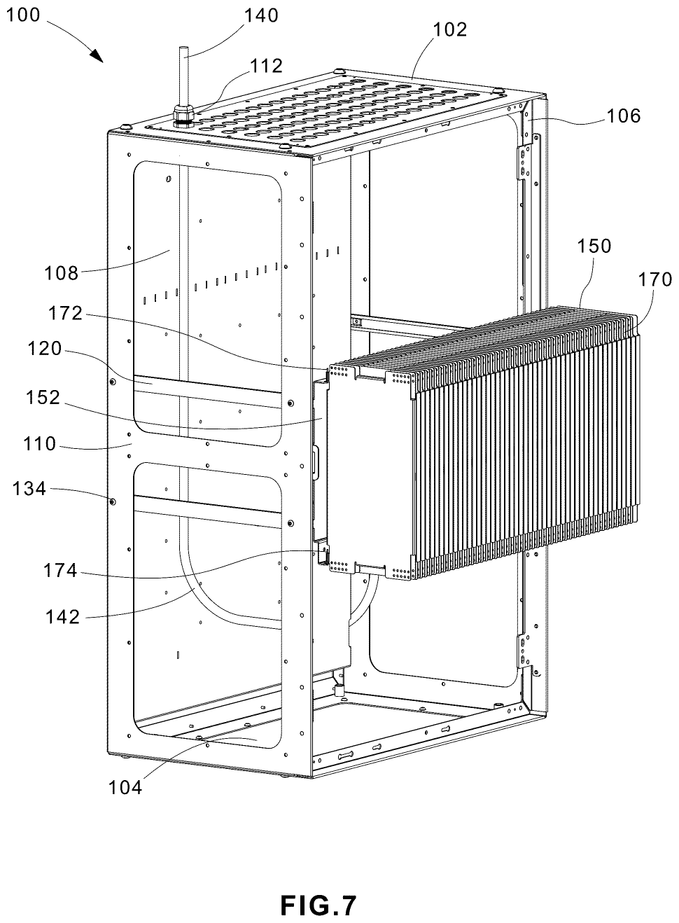

The splice tray holder assembly 150 is attached to the linear guides 120 of the enclosure 100 which enables the splice tray holder assembly 150 to be pulled forward. As shown in FIG. 7, the splice tray holder assembly 150 can be pulled out of the enclosure completely. Note that, when the splice tray holder assembly is pulled forward, the cable slack loop extends to occupy the depth of the enclosure (FIG. 7) instead of the height of the enclosure (FIG. 6). In the extended position, the splice trays 170 can be sorted through, like a rolodex, because they are no longer constrained by the sides 110 of the enclosure 100. With the cable 140 below and behind the splice trays 170 and the splice tray holder 150, the number of splice trays 170 can increase. The splice trays 170 can now occupy the entire width of the enclosure when in a retracted position. As a result, the quantity of splice trays can be doubled over the prior art enclosure illustrated in FIG. 1.

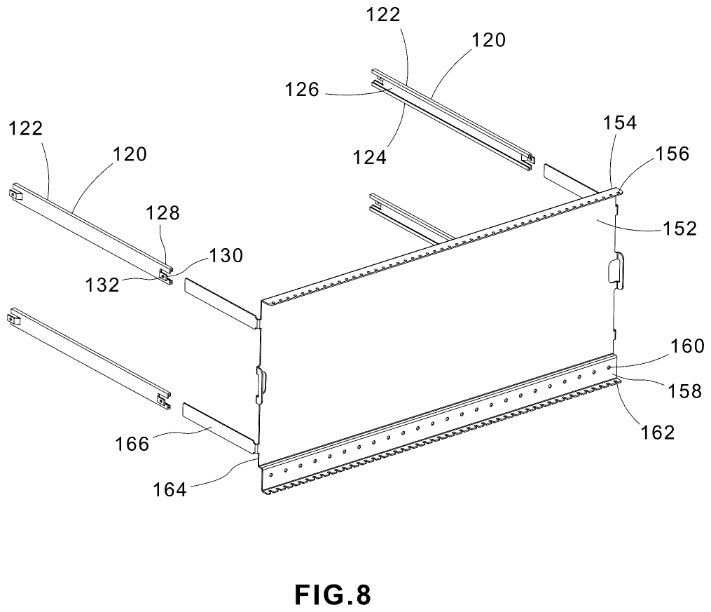

FIG. 8 shows an exploded view of the splice tray holder assembly 150 (splice trays are omitted for clarity). The tabs 166 are designed to slide inside the channel 126 of the linear guides 120 which are attached to the sides 110 of the enclosure 100 with fasteners 134. In an alternate embodiment, the tabs and linear guides may be replaced with drawer slides for smoother operation.

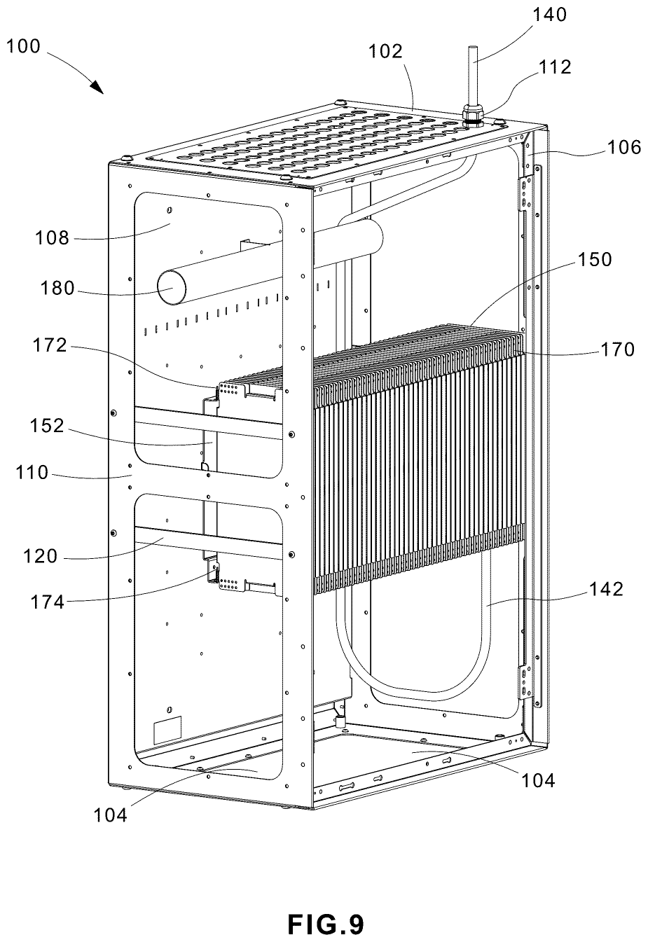

As shown in FIG. 6 and as described above, the cable slack loop 142 is to be confined behind the splice tray holder assembly 150, and preferably close to the rear of the enclosure 100. Because of this requirement, any cables entering the enclosure near the front of the enclosure must be guided towards the rear of the enclosure. FIG. 9 illustrates an enclosure 100 with cable 140 coming in at a cable entry 112 at the front 106 of the enclosure 100. A cylindrical-shaped cable guide 180 is removably attached to the back 108 of the enclosure 100 to guide the cable 140, as needed. Alternatively, the back 108 of the enclosure 100 may feature a multitude of threaded holes and slots to which cable management devices, such as standard Panduit cable anchors or cable tie anchors, can be attached.

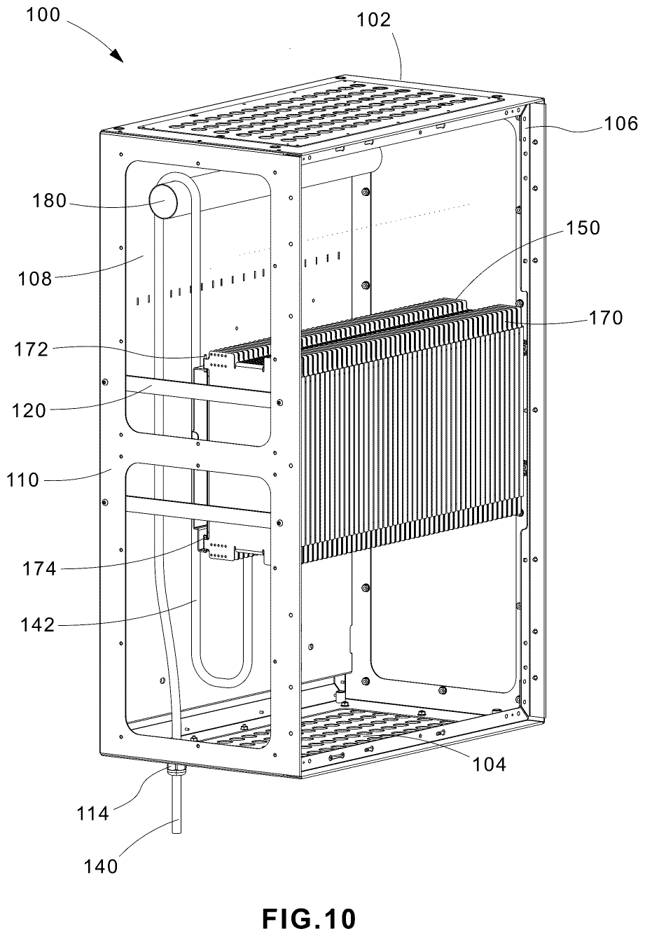

FIG. 10 illustrates an enclosure 100 with the cable 140 coming in at a cable entry 114 at the bottom 104 of the enclosure 100. In this case, the cylindrical cable guide 180, or other cable management device, is required to route the cable 140 to near the top 102 of the enclosure 100, so it can form a slack loop 142 below the splice trays 170 to accommodate the splice tray holder assembly 150 as described above.

The wall mount enclosures illustrated in the figures show cables with low fiber counts, however a large fiber count cable can also be accommodated in the wall mount enclosure of the present invention. A larger fiber count cable would utilize a top plate designed for larger outer diameter cables and would also require cable break out plates.

The wall mount enclosure of the present invention is designed to maximize the number of splice trays, while retaining the benefit of tray sorting. The innovations described above can be applied to standard and double wide wall mount enclosures, as well as a bite sized wall mount enclosure.

Furthermore, while the particular preferred embodiments of the present invention have been shown and described, it will be obvious to those skilled in the art that changes and modifications may be made without departing from the teaching of the invention. The matter set forth in the foregoing description and accompanying drawings is offered by way of illustration only and not as limitation.

What is claimed is:

1. A wall mount enclosure for managing and organizing fiber distribution, the wall mount enclosure comprising:
a top, a bottom, a back, a front, and two sides;
linear guides secured to the sides of the wall mount enclosure; and
a splice tray holder assembly attached to the linear guides, the splice tray holder assembly including a splice tray holder and a plurality of splice trays secured to the splice tray holder;
wherein the splice tray holder includes a top with a plurality of holes, a bottom with a plurality of slots, and sides with tabs extending from the splice tray holder, wherein the tabs are positioned within the linear guides;
whereby the splice tray holder assembly slides out of the wall mount enclosure providing access to the splice trays installed on the splice tray holder.

2. The wall mount enclosure of claim 1, wherein each linear guide include a top and a bottom that define a channel therebetween, wherein the tabs are positioned within each channel.

3. The wall mount enclosure of claim 2, wherein the tabs slide within the channels enabling the splice tray holder assembly to be pulled completely out of the wall mount enclosure.

4. The wall mount enclosure of claim 3, wherein each splice tray has an upper pin and a lower pin, the upper pin is positioned in one of the plurality of holes in the top of the splice tray holder and the lower pin is positioned in one of the plurality of slots at the bottom of the splice tray holder, whereby when the splice tray holder assembly is pulled out of the wall mount enclosure the splice trays are sorted and rotated about the upper pin and the lower pin as the splice trays are no longer constrained by the wall mount enclosure.

5. The wall mount enclosure of claim 1, wherein each linear guide include ends with a tab having a hole for receiving a fastener to mount each linear guide to one of the sides of the wall mount enclosure.

6. The wall mount enclosure of claim 1, wherein the top of the wall mount enclosure includes a cable entry near the back of the wall mount enclosure; wherein a cable enters the wall mount enclosure through the cable entry; and wherein the cable has a cable slack loop routed in the enclosure behind the splice tray holder assembly.

7. The wall mount enclosure of claim 6, wherein the cable slack loop extends a depth of the wall mount enclosure when the splice tray holder assembly slides out of the wall mount enclosure.

8. The wall mount enclosure of claim 6, wherein the cable slack loop is confined behind the splice tray holder assembly.

9. The wall mount enclosure of claim 1, wherein the top of the wall mount enclosure includes a cable entry near the front of the wall mount enclosure; wherein a cable enters the wall mount enclosure through the cable entry and is guided over a cylindrical cable guide towards the back of the wall mount enclosure, whereby the cable has a cable slack loop routed in the enclosure behind the splice tray holder assembly.

10. The wall mount enclosure of claim 1, wherein the bottom of the wall mount enclosure includes a bottom cable entry near the back of the wall mount enclosure; wherein a cable enters the wall mount enclosure through the bottom cable entry, the cable is directed towards the top of the enclosure and is guided over a cylindrical cable guide, whereby the cable has a cable slack loop routed in the enclosure behind the splice tray holder assembly.
